(19) United States
(12) Patent Application Publication
(10) Pub. No.: US 2025/0162901 A1
(43) Pub. Date: May 22, 2025

(54) METHOD FOR MANUFACTURING TiO2 POWDER AND TiO2 POWDER PREPARED BY THE SAME

(71) Applicants: Ji Seok KIM, Incheon (KR); Che Hoo CHO, Seoul (KR)

(72) Inventors: Ji Seok KIM, Incheon (KR); Che Hoo CHO, Seoul (KR)

(21) Appl. No.: 18/955,916

(22) Filed: Nov. 21, 2024

(30) Foreign Application Priority Data
Nov. 21, 2023 (KR) 10-2023-0162336

(51) Int. Cl. C01G 23/08

(52) U.S. Cl. CPC C01G 23/08; C01P 2004/03; C01P 2004/64

(57) ABSTRACT

An aspect of a method for manufacturing TiO2 powder according to an embodiment of the present invention for achieving the above-described object is a method for manufacturing TiO₂ powder comprising: capturing NH₃ and TiCl₄ from a residue after forming a Ti—N layer; dissolving the NH₃ and TiCl₄ in a solvent to prepare a mixture; obtaining TiO₂ and NH₄Cl from the mixture; and separating TiO₂ powder from the obtained TiO₂ and NH₄Cl.

### CROSS REFERENCE TO RELATED APPLICATION

The present application claims priority to Korean Patent Application No. 10-2023-0162336, filed Nov. 21, 2023, the entire contents of which is incorporated herein for all purposes by this reference.

### BACKGROUND OF THE INVENTION

### Field of the Invention

The present invention relates to a method for manufacturing TiO₂ powder and TiO₂ powder prepared by the same.

### Description of the Related Art

Photocatalysts must be fundamentally stable, and, in order to function, they must have the ability to absorb light and oxidize other substances. Although mainly used as a white paint, TiO₂ exhibits suitable properties as a photocatalyst, and, when mixed with other dyes or colored organic substances, it may also perform the photocatalytic function with light in the visible light range.

Meanwhile, NH₃ and TiCl₄ react on a wafer to form a Ti—N layer in a process of manufacturing a semiconductor forming a Ti—N layer. However, the amount of NH₃ and TiCl₄ used to form a Ti—N layer is actually only about 10% of the supply, and the remaining 90% is discharged and thrown away. Therefore, it is necessary to recover the residual NH₃ and TiCl₄ discharged in terms of resource recycling, but no technology has been proposed to solve such problem.

### PRIOR ART DOCUMENT

### Patent Document

Korean Patent No. 1872291 (Title: Method for manufacturing Photocatalytic Filter Using Titanium Scrap)
Korean Patent No. 2044380 (Title: Method for manufacturing Titania Nano-Particles)
Korean Laid-open Patent Publication No. 2018-0008326 (Title: Method for manufacturing Surface-Modified Titanium Dioxide)

### SUMMARY OF THE INVENTION

The present invention aims to solve the problems of the prior art as described above, and an object of the present invention is to provide a method for manufacturing TiO₂ powder from a mixture discharged when NH₃ and TiCl₄ are reacted on a wafer to form a Ti—N layer.

In order to achieve the objectives, an aspect of a method for manufacturing TiO₂ powder according to an embodiment of the present invention for achieving the above-described object is a method for manufacturing TiO₂ powder comprising: capturing NH₃ and TiCl₄ from a residue after forming a Ti—N layer; dissolving the NH₃ and TiCl₄ in a solvent to prepare a mixture; obtaining TiO₂ and NH₄Cl from the mixture; and separating TiO₂ powder from the obtained TiO₂ and NH₄Cl.

In an aspect of an embodiment of the present disclosure, wherein the TiO₂ powder is nanoparticles.

In an aspect of an embodiment of the present disclosure, wherein the vanadium carbide is formed by refining vanadium oxide and a carbon compound, followed by mixing, to prepare a mixture of the vanadium oxide and the carbon compound, and subjecting the mixture to heat-treatment under vacuum and normal pressure.

In an aspect of an embodiment of the present disclosure, wherein the vanadium carbide has a molar ratio of vanadium to carbon of 2:1, 3:2, or 4:3.

In an aspect of an embodiment of the present disclosure, wherein the Max using vanadium carbide excludes the use of a vanadium metal.

In an aspect of an embodiment of the present disclosure, wherein the carbon content in the Max using vanadium carbide is 8 to 14 wt %.

In an aspect of an embodiment of the present disclosure, wherein the solvent is selected from the group consisting of nitric acid, ammonia, hydrogen peroxide, hydrochloric acid and combinations thereof.

In an aspect of an embodiment of the present disclosure, wherein, in the step of preparing the mixture, the NH₃ and TiCl₄ are dissolved in the solvent and reacted at a temperature of from 25° C. to 350° C.

In an aspect of an embodiment of the present disclosure, wherein, in the step of preparing the mixture, the NH₃ and TiCl₄ are dissolved in the solvent and reacted under a pressure of from 1 bar to 10 bar.

In an aspect of an embodiment of the present disclosure, wherein, in the step of obtaining the TiO₂ and NH₄Cl, the TiO₂ and NH₄Cl are obtained from the mixture at a temperature of 200° C. to 1,000° C.

In an aspect of an embodiment of the present disclosure, wherein the method further comprises additionally heat-treating the obtained TiO₂ powder.

In an aspect of an embodiment of the present disclosure, wherein, in the step of additionally heat-treating the TiO₂ powder, the obtained TiO₂ powder is heat-treated at a temperature of from 200° C. to 1,000° C.

Another aspect of a method for manufacturing TiO₂ powder according to an embodiment of the present invention is a method for manufacturing TiO₂ powder being: wherein TiO₂ and NH₄Cl are obtained from a mixture prepared by dissolving NH₃ and TiCl₄ captured from a residue after forming a TiN layer in a solvent, and TiO₂ powder is separated therefrom.

An aspect of a method for TiO₂ powder according to an embodiment of the present invention prepared by the method of any one of claims 1 to 13.

In a method for manufacturing TiO₂ powder and TiO₂ powder prepared thereby according to an embodiment of the present invention, TiO₂ and NH₄Cl are obtained from residual NH₃ and TiCl₄ that are discharged without reacting during the process of forming a Ti—N layer on a wafer, and TiO₂ powder is separated therefrom. Therefore, according to an embodiment of the present invention, TiO₂ powder can be produced by recycling the residual NH₃ and TiCl₄ that are discharged.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1 to 5 show SEM images on the size of TiO₂ powder particles.

FIG. 6 shows graphs on the size of TiO₂ powder particles according to temperature.

FIG. 7 shows graphs on the ratio of crystal structures of anatase and a mixed phase of anatase and rutile according to pH control.

FIG. 8 shows images of TiO₂ powder according to temperature and time.

FIG. 9 shows a graph on changes in solubility according to temperature.

### DETAILED DESCRIPTION OF THE INVENTION

Hereinafter, a method for manufacturing TiO₂ powder according to an embodiment of the present invention will be described in more detail with reference to the drawings attached hereto.

The method for manufacturing TiO₂ powder according to an embodiment of the present invention for achieving the above-described object comprises capturing NH₃ and TiCl₄ from a residue after forming a Ti—N layer; dissolving the NH₃ and TiCl₄ in a solvent to prepare a mixture; reacting the mixture to obtain TiO₂ and NH₄Cl; and separating the obtained TiO₂ and NH₄Cl to obtain TiO₂ powder.

In a process of manufacturing a semiconductor forming a Ti—N layer, NH₃ and TiCl₄ are reacted on a wafer to form a Ti—N layer. The NH₃ and TiCl₄ discharged after forming the layer are captured to prepare TiO₂ powder.

In the step of preparing the mixture, the solvent may be used to adjust the ratio of anatase or a mixed phase of anatase and rutile as the crystal structure of TiO₂ prepared by dissolving the mixture of NH₃ and TiCl₄ by adjusting the acidity to be between-0.02 and 1. In particular, the color of the obtained TiO₂ powder may be controlled by heat-treating the TiO₂ having the rutile structure in a temperature range of from 200° C. to 800° C. When the temperature range is 1,000° C. or higher, the final obtained TiO₂ powder structure may be changed to a rutile structure. In addition, the molar ratio of NH₃ and TiCl₄ to the solvent may be controlled to from 0.01:1 to 0.13:1, and the solvent comprises one selected from the group consisting of nitric acid, ammonia, hydrogen peroxide, hydrochloric acid, and combinations thereof.

The step of preparing the mixture may comprise using a hydration reaction or a high-pressure reaction for solid-liquid separation. The hydration reaction may be performed at a temperature of from 25° C. to 100° C. The size of the TiO₂ particles generated in the room temperature range is in the range of from 2 nm to 10 nm. The size of the particles generated in a NH₄Cl solution is actually very small, which is because NH₄Cl inhibits the growth of the particles. When TiO₂ is generated, the size of the crystal particles maintains a nano size. However, they may be produced to form aggregates and be filtered depending on the heating temperature. Therefore, if the aggregates are formed to a certain size and then filtered and crushed to form particles, the size of the particles may be formed to be about 10 nm. The ammonia generated in the present invention may inhibit the growth of TiO₂ particles and, thus, is recovered as NH₄Cl.

Meanwhile, since the size of the particles prepared in the hydration reaction is very small, a high-pressure reaction may be used as a method of coagulating them to facilitate filtering. The temperature range of the high-pressure reaction may be 25° C. to 350° C., and the pressure range may be 1 bar to 10 bar. The TiO₂ powder prepared to have a large particle size by controlling the temperature and pressure conditions as described above may be filtered and separated into solid and liquid.

The particle size may be controlled to 10 nm to 500 nm by heat-treating a mixture that has undergone a hydration reaction or a high-pressure reaction at a temperature of from 300° C. to 1,100° C. for 10 to 120 minutes.

In addition, TiO₂ having a 100% rutile crystal structure may be produced into a yellow dye by additionally heat-treating TiO₂ at 300° C. to 1,000° C. In particular, yellow dyes at various concentrations may be obtained depending on the temperature range.

The TiO₂ powder produced from the above-described preparation method may be obtained as nanoparticles, and the size of the nanoparticle powder may be in the range of from 10 nm to 20 nm.

Hereinafter, preparation examples and experimental examples of the present invention are described. However, these preparation examples and experimental examples are intended to explain the constitution and effect of the present invention more specifically, and the scope of the present invention is not limited thereto.

### Embodiment

### <Examples 1 to 5> Preparation Example 1: Preparation of TiO₂ Powder

NH₃ and TiCl₄ discharged from a reaction device after forming a TiN layer were condensed in a trap and captured as a mixture. Ultrapure water was added as a solvent to the mixture of the condensed NH₃ and TiCl₄ in a molar ratio of from 1:0.01 to 0.13 and mixed. The mixture was dissolved by heating at 45° C. for 2 hours. The dissolved mixture was obtained by forming TiO₂ and NH₄Cl at room temperature and pressure. The formed TiO₂ and NH₄Cl were first separated by using a filter, and then the TiO₂ powder and NH₄Cl were subjected to a second solid-liquid separation.

### <Preparation Example 2> Preparation of TiO₂ Powder

TiO₂ powder was prepared in the same manner as in Preparation Example 1 above, but the heating conditions were changed to 70° C. for 1.5 hours.

### <Preparation Example 3> Preparation of TiO₂ Powder

TiO₂ powder was prepared in the same manner as in Preparation Example 1 above, but the heating conditions were changed to 90° C. for 2 hours.

### <Preparation Example 4> Preparation of TiO₂ Powder

TiO₂ powder was prepared in the same manner as in Preparation Example 1 above, but the conditions for first heating were 70° C. for 1 hour and 20 minutes, and the conditions for second heating were 90° C. for 2 hours.

### <Preparation Example 5> Preparation of TiO₂ Powder

TiO₂ powder was prepared in the same manner as in Preparation Example 1 above, but the conditions for first heating were 50° C. for 1 hour and 20 minutes, and the conditions for second heating were 90° C. for 2 hours.

### <Preparation Example 6> Preparation of TiO₂ Powder

TiO₂ powder was prepared in the same manner as in Preparation Example 1 above, but the heating conditions were changed to 800° C. for 0.5 hour.

### <Preparation Example 7> Preparation of TiO₂ Powder

TiO₂ powder was prepared in the same manner as in Preparation Example 1 above, but the heating conditions were changed to 600° C. for 1 hour.

### <Preparation Example 8> Preparation of TiO₂ Powder at High Temperature and Pressure

NH₃ and TiCl₄ discharged from a reaction device after forming a TiN layer were condensed in a trap and captured as a mixture. Ultrapure water was added as a solvent to the mixture of the condensed NH₃ and TiCl₄ in a molar ratio of from 1:0.01 to 0.13 and mixed. The mixture was dissolved by reaction at 150° C. and 4 bar. The dissolved mixture was heated at 150° C. and 4 bar for 180 minutes to form TiO₂ and NH₄Cl. The formed TiO₂ and NH₄Cl were first separated by using a filter, and then the TiO₂ powder and NH₄Cl were subjected to a second solid-liquid separation.

### <Preparation Example 9> Changes in Particle Size of TiO₂ Powder According to Heat Treatment Conditions

NH₃ and TiCl₄ discharged from a reaction device after forming a TiN layer were condensed in a trap and captured as a mixture. Ultrapure water was added as a solvent to the mixture of the condensed NH₃ and TiCl₄ in a molar ratio of from 1:0.01 to 0.13 and mixed. The conditions for obtaining TiO₂ and NH₄Cl were the same as those for Preparation Examples 1 to 3, 6 and 7. The TiO₂ was obtained by controlling the particle size of TiO₂ by heating the mixture for 20 to 180 minutes under the temperature conditions of Table 1 below.

TABLE 1

| Heating conditions | 1 | 2 | 3 | 4 | 5 |
|---|---|---|---|---|---|
| Temperature(° C.) | 200 | 400 | 600 | 800 | 1,000 |

### <Preparation Example 10> Preparation of TiO₂ Powder Having a Rutile Crystal Structure

NH₃ and TiCl₄ discharged from a reaction device after forming a TiN layer were condensed in a trap and captured as a mixture. Ultrapure water was added as a solvent to the mixture of the condensed NH₃ and TiCl₄ in a molar ratio of from 1:0.1 to 0.25, and mixed. The mixture was reacted at 25 to 130° C. and 1 to 4 bar for 30 to 180 minutes to obtain TiO₂ and NH₄Cl. Thereafter, NH₄Cl was separated from the formed TiO₂ by using a filter, and then the TiO₂ powder was subjected to solid-liquid separation. The obtained TiO₂ powder was additionally heat-treated at a temperature range of from 300° C. to 800° C. for 30 to 120 minutes to prepare yellow dyes having various concentrations.

### <Preparation Example 11> Preparation of TiO₂ Powder Having Rutile and Anatase Crystal Structures

NH₃ and TiCl₄ discharged from a reaction device after forming a TiN layer were condensed in a trap and captured as a mixture. Ultrapure water was added as a solvent to the mixture of the condensed NH₃ and TiCl₄ in a molar ratio of from 0.02:1 and mixed. The mixture was heated and reacted at 25 to 130° C. and 1 to 3 bar for 120 minutes to obtain TiO₂ and NH₄Cl. The TiO₂ and NH₄Cl formed at this time were first separated by using a filter, and then the TiO₂ powder and NH₄Cl were subjected to a second solid-liquid separation. The obtained TiO₂ powder was additionally heat-treated at a temperature range of from 200° C. to 1,000° C. for 30 to 120 minutes to stabilize the crystal structure and control the crystal structures of anatase and a mixed phase of anatase and rutile to prepare TiO₂ powder.

Table 2 below shows the results of analyzing the size (nm) of X-RD particles according to the Scherrer Equation of Preparation Examples 1 to 5.

TABLE 2

| | Preparation | Preparation | Preparation | Preparation | Preparation |
|---|---|---|---|---|---|
| Conditions | Example 1 | Example 2 | Example 3 | Example 4 | Example 5 |
| Size(nm) | 8.49 | 9.54 | 10.05 | 9.38 | 8.96 |

The size of the particles prepared in a NH₄Cl solution is actually very small, which is because NH₄Cl inhibits the growth of particles. Therefore, aggregates were formed to a certain size, followed by crushing, to prepare particles such that the particle size was about 10 nm.

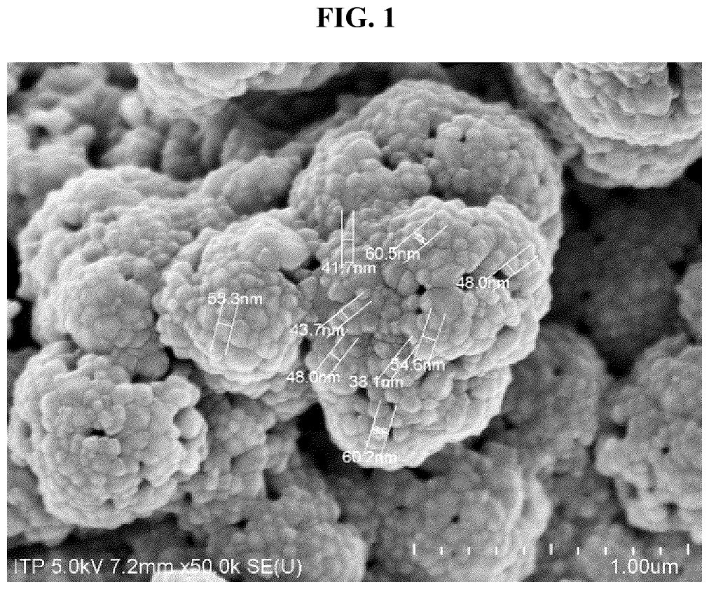

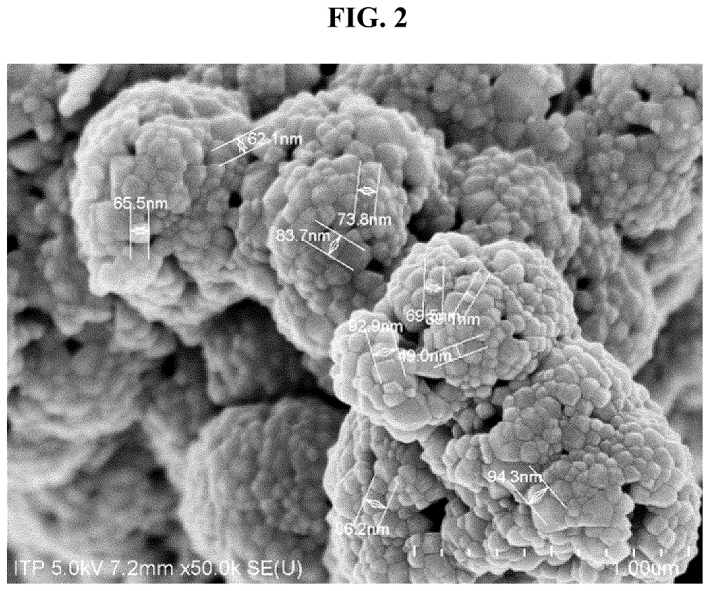

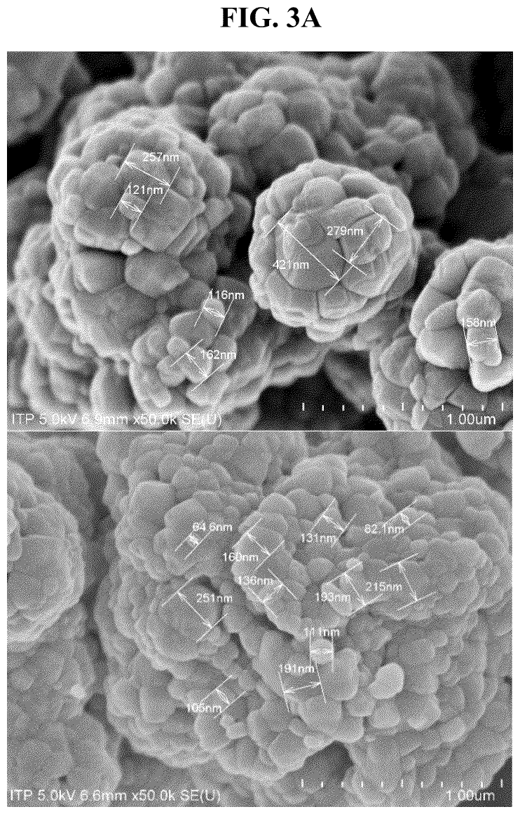

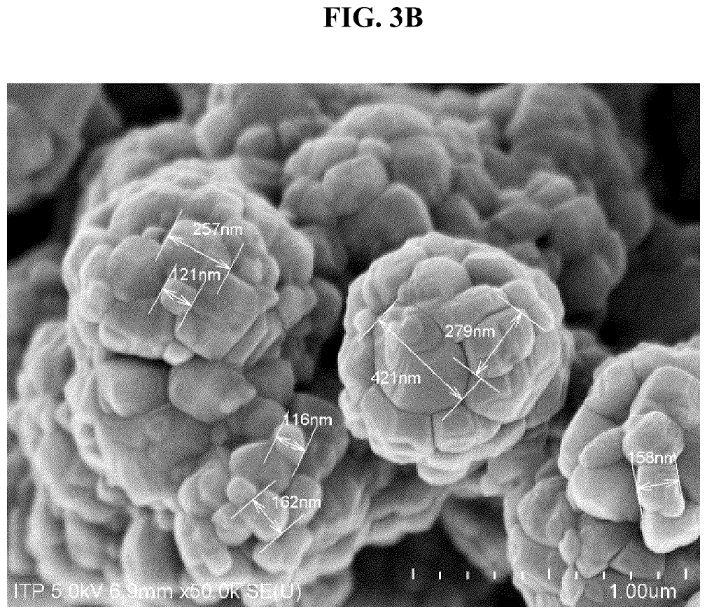

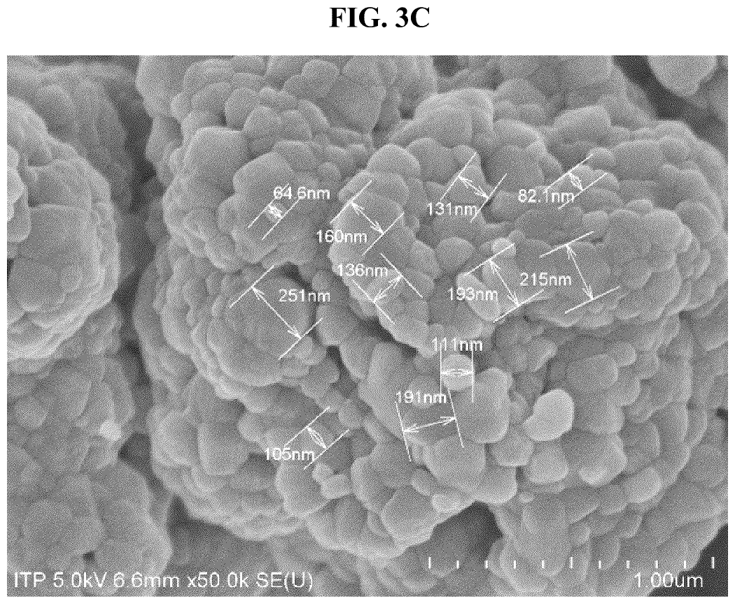

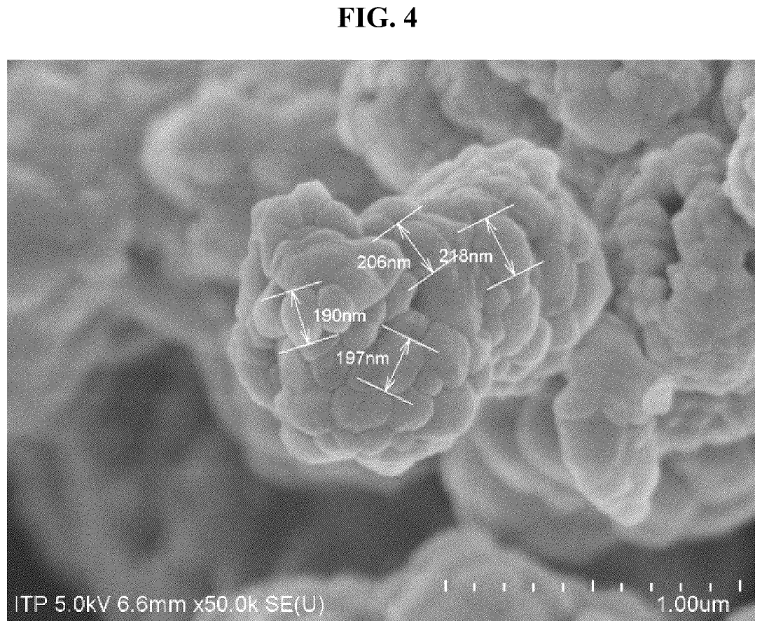

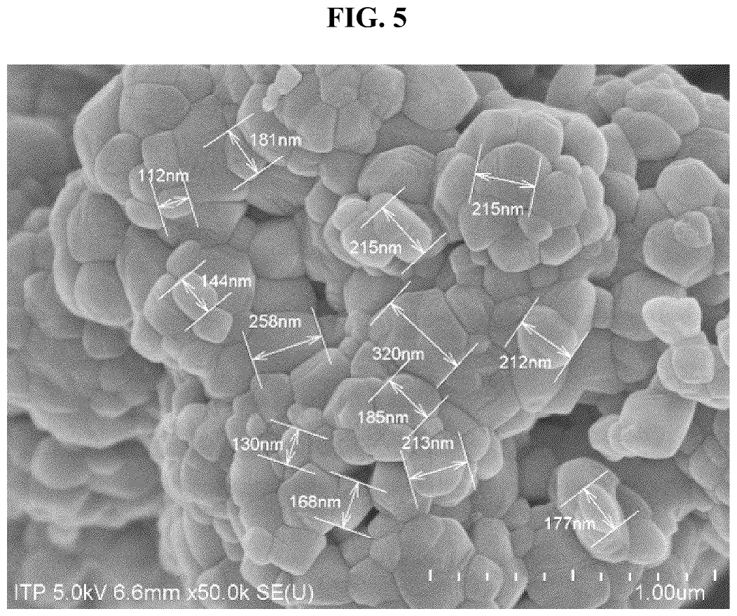

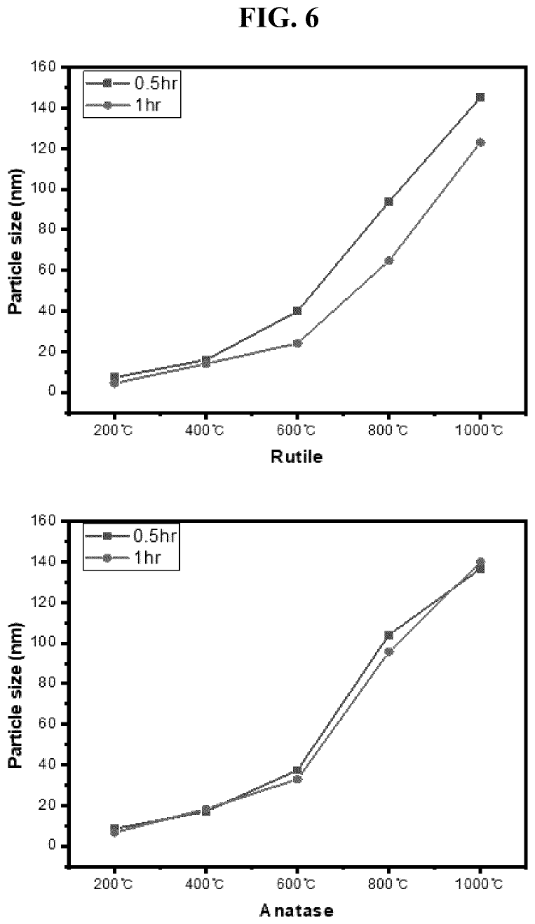

FIGS. 1 to 5 show SEM images on the size of TiO₂ powder particles obtained according to the heat treatment temperature of Preparation Example 9. As shown in FIG. 6, TiO₂ powder could be produced by controlling the size of the powder particles according to the heat treatment temperature.

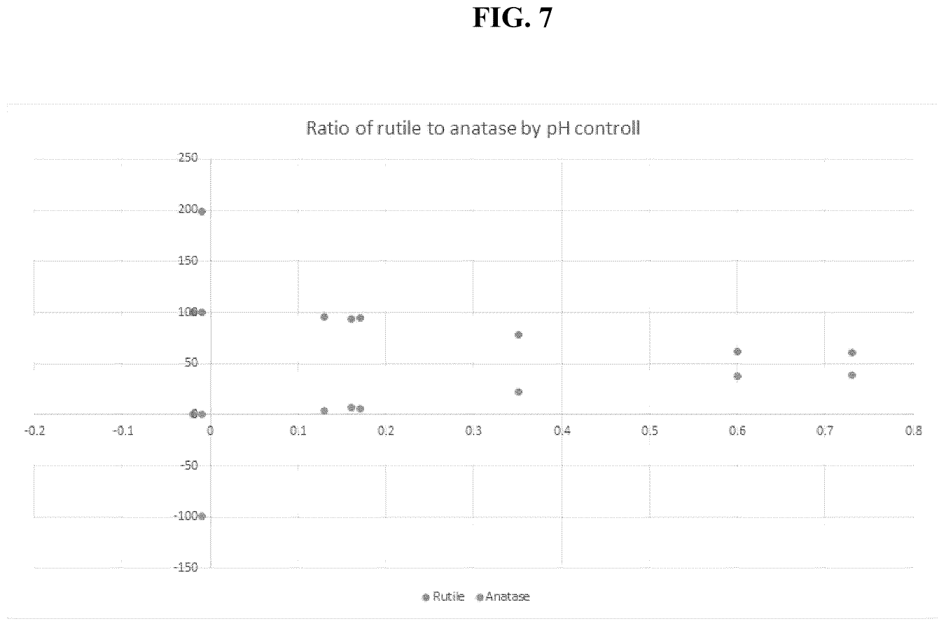

FIG. 7 shows graphs on the ratio of crystal structures of anatase and a mixed phase of anatase and rutile according to pH control of Preparation Examples 10 and 11. Different crystal structures could be obtained by controlling the pH by adding a solvent.

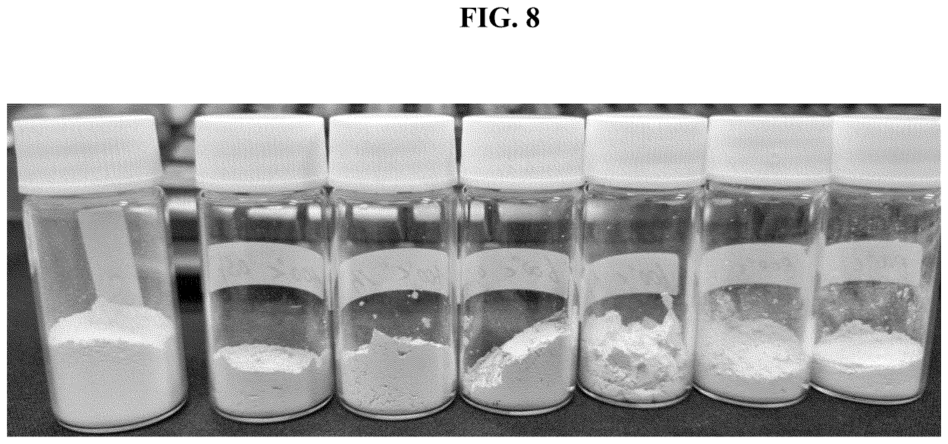

FIG. 8 shows powders obtained by adjusting the heat treatment temperature of the TiO₂ powder having a 100% rutile structure obtained from Preparation Example 10 to a temperature of from 200° C. to 1,000° C. and adjusting the time to from 10 to 120 minutes. TiO₂ powders as yellow dyes having various concentrations could be prepared by adjusting the temperature and time.

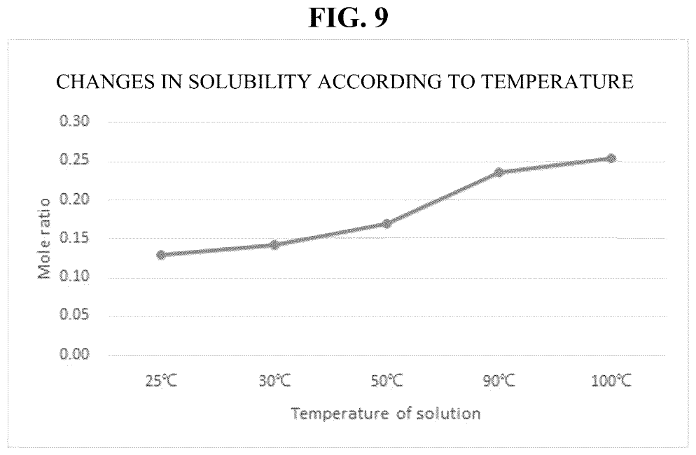

FIG. 9 shows a graph on the difference in solubility according to temperature. It was confirmed that the solubility increases as the temperature increases.

What is claimed is:

1. A method for manufacturing TiO₂ powder comprising:
capturing NH₃ and TiCl₄ from a residue after forming a Ti—N layer;
dissolving the NH₃ and TiCl₄ in a solvent to prepare a mixture;
obtaining TiO₂ and NH₄Cl from the mixture; and
separating TiO₂ powder from the obtained TiO₂ and NH₄Cl.

2. The method for manufacturing TiO₂ powder of claim 1,
wherein the TiO₂ powder is nanoparticles.

3. The Max using vanadium carbide according to claim 1,
wherein the vanadium carbide is formed by refining vanadium oxide and a carbon compound, followed by mixing, to prepare a mixture of the vanadium oxide and the carbon compound, and subjecting the mixture to heat-treatment under vacuum and normal pressure.

4. The method for manufacturing TiO₂ powder of claim 1,
wherein the vanadium carbide has a molar ratio of vanadium to carbon of 2:1, 3:2, or 4:3.

5. The method for manufacturing TiO₂ powder of claim 1,
wherein the Max using vanadium carbide excludes the use of a vanadium metal.

6. The method for manufacturing TiO₂ powder of claim 1,
wherein the carbon content in the Max using vanadium carbide is 8 to 14 wt %.

7. The method for manufacturing TiO₂ powder of claim 1,
wherein the solvent is selected from the group consisting of nitric acid, ammonia, hydrogen peroxide, hydrochloric acid and combinations thereof.

8. The method for manufacturing TiO₂ powder of claim 1,
wherein, in the step of preparing the mixture,
the NH₃ and TiCl₄ are dissolved in the solvent and reacted at a temperature of from 25° C. to 350° C.

9. The method for manufacturing TiO₂ powder of claim 1,
wherein, in the step of preparing the mixture,
the NH₃ and TiCl₄ are dissolved in the solvent and reacted under a pressure of from 1 bar to 10 bar.

10. The method for manufacturing TiO₂ powder of claim 1,
wherein, in the step of obtaining the TiO₂ and NH₄Cl,
the TiO₂ and NH₄Cl are obtained from the mixture at a temperature of 200° C. to 1,000° C.

11. The method for manufacturing TiO₂ powder of claim 1,
wherein the method further comprises additionally heat-treating the obtained TiO₂ powder.

12. The method for manufacturing TiO₂ powder of claim 11,
wherein, in the step of additionally heat-treating the TiO₂ powder, the obtained TiO₂ powder is heat-treated at a temperature of from 200° C. to 1,000° C.

13. A method for manufacturing TiO₂ powder,
wherein TiO₂ and NH₄Cl are obtained from a mixture prepared by dissolving NH₃ and TiCl₄ captured from a residue after forming a TiN layer in a solvent, and TiO₂ powder is separated therefrom.

14. TiO₂ powder prepared by the method of claim 1.
